(19) United States
(12) Patent Application Publication
(10) Pub. No.: US 2014/0017607 A1
(43) Pub. Date: Jan. 16, 2014

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicant: FUJI XEROX CO., LTD., Tokyo (JP)

(72) Inventors: Yoshifumi IIDA, Kanagawa (JP); Takeshi IWANAGA, Kanagawa (JP); Yuka ZENITANI, Kanagawa (JP); Daisuke TOMITA, Kanagawa (JP)

(73) Assignee: FUJI XEROX CO., LTD., Tokyo (JP)

(21) Appl. No.: 13/890,722

(22) Filed: May 9, 2013

(30) Foreign Application Priority Data
Jul. 13, 2012 (JP) 2012-158115

(51) Int. Cl. G03G 9/08

(52) U.S. Cl. CPC G03G 9/08
USPC 430/108.6; 430/123.51; 399/262; 399/111; 399/252

(57) ABSTRACT

An electrostatic charge image developing toner includes toner particles, and silica composite particles that contain silicon oxide and from 0.001% by weight to 10% by weight of titanium, and have an average particle size of from 30 nm to 500 nm, a particle size distribution index of from 1.10 to 1.50, and an average circularity of from 0.50 to 0.85.

### CROSS-REFERENCE TO RELATED APPLICATIONS

This application is based on and claims priority under 35 USC 119 from Japanese Patent Application No. 2012-158115 filed Jul. 13, 2012.

### BACKGROUND

1. Technical Field

The present invention relates to an electrostatic charge image developing toner, an electrostatic charge image developer, a toner cartridge, a process cartridge, an image forming apparatus, and an image forming method.

2. Related Art

There has been an attempt to control toner properties by adding a surface-treated additive to a toner.

### SUMMARY

According to an aspect of the invention, there is provided an electrostatic charge image developing toner including toner particles, and silica composite particles that contain silicon oxide and from 0. 001% by weight to 10% by weight of titanium, and have an average particle size of from 30 nm to 500 nm, a particle size distribution index of from 1.10 to 1.50, and an average circularity of from 0.50 to 0.85.

### BRIEF DESCRIPTION OF THE DRAWINGS

Exemplary embodiments of the present invention will be described in detail based on the following figures, wherein:

FIG. 1 is a schematic diagram showing a configuration of an example of an image forming apparatus according to an exemplary embodiment; and

FIG. 2 is a schematic diagram showing a configuration of an example of a process cartridge according to the exemplary embodiment.

### DETAILED DESCRIPTION

Hereinafter, an exemplary embodiment as an example of the invention will be described.

Electrostatic Charge Image Developing Toner

An electrostatic charge image developing toner (hereinafter, referred to as “toner”) according to an exemplary embodiment has: toner particles; and silica composite particles that contain silicon oxide and from 0.001% by weight to 10% by weight of titanium relative to the total amount of the silica composite particles, have an average particle size of from 30 nm to 500 nm, a particle size distribution index of from 1.1 to 1.5, and an average circularity of from 0.5 to 0.85.

By virtue of the above-described configuration, the toner according to this exemplary embodiment has excellent transfer efficiency and suppresses image density fluctuation and occurrence of fogging.

The reason for this is not clear, but it is thought that this is due to the following reasons.

The silica composite particles having the above-described average particle size, particle size distribution index, and average circularity have such characteristics as to have an appropriate size, a uniform particle size distribution, and an irregular shape with more irregularities than a complete sphere.

Since the silica composite particles have an appropriate size and a uniform particle size distribution, the adhesion property between particles is smaller than particle groups having a wide particle size distribution, and thus it is thought that friction between particles does not easily occur. As a result, it is thought that silica composite particles having excellent fluidity are externally added to the toner particles without unevenness.

In addition, since the silica composite particles have an appropriate size and an irregular shape, it is thought that embed into the toner particles upon adhesion to the toner particles, and uneven distribution and separation due to rolling do not easily occur, and destruction due to mechanical load does not easily occur, as compared with the case of a spherical shape (shape having an average circularity greater than 0.85).

Therefore, it is thought that the silica composite particles enhance dispersibility to the toner particles and the maintenance of the fluidity of the toner particles. That is, since the silica composite particles having the above-described average particle size, particle size distribution index, and average circularity have such characteristics as to have an appropriate size and an irregular shape with more irregularities than a complete sphere, the silica composite particles have a larger contact area with the toner particles than in the case of a complete sphere. Therefore, it is thought that separating out of the silica composite particles is suppressed.

In addition, since the silica composite particles contain titanium in the above range, it is thought that there is a part in which the titanium is exposed on the surface of the silica composite particles. Therefore, it is thought that the silica composite particles are more easily adhered to the toner particles than silica particles, and thus separating out of the silica composite particles is suppressed. It is thought that the reason for this is that titanium has a higher affinity for the surface of the toner particles than silica.

As described above, when separating out of the silica composite particles is suppressed, the silica composite particles are suppressed from being developed and remaining alone on an electrostatic latent image holding member, and thus the electrostatic latent image holding member easily obtains a target potential. As a result, it is thought that image density fluctuation is suppressed.

In addition, since the silica composite particles contain titanium particles at the above content, charging is maintained without a reduction in the resistance and the charge exchangeability is thus improved. As a result, it is thought that fogging is suppressed.

Furthermore, in addition to the above-described improvement in the charge exchangeability of the toner by titanium, the silica composite particles have an appropriate size, and as a result, it is thought that transferability is also improved.

From the above description, it is thought that the toner according to this exemplary embodiment has excellent transfer efficiency and suppresses image density fluctuation and occurrence of fogging.

Since titanium is present in a part of the surface of the silica composite particles by mixing in the titanium, the resistance is not considerably reduced, and thus there are no voids. Since the silica composite particles have an irregular shape, it is also thought that cleanability increases.

Hereinafter, a configuration of the toner will be described in detail.

The toner is configured to contain toner particles and silica composite particles as an external additive.

Toner Particles

The toner particles are configured to contain, for example, a binder resin, and if necessary, a colorant, a release agent, and other additives.

The binder resin is not particularly limited. Examples thereof include homopolymers of monomers such as styrenes such as styrene, p-chlorostyrene, and α-methylstyrene; vinyl group-containing esters such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate; vinyl nitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; and polyolefins such as ethylene, propylene, and butadiene, and copolymers obtained by combining two or more types of these monomers, as well as mixtures thereof. The examples also include non-vinyl condensed resins such as epoxy resins, polyester resins, polyurethane resins, polyamide resins, cellulose resins, polyether resins, mixtures of the resins with the vinyl resins, and graft polymers obtained by polymerizing vinyl monomers with the coexistence of these resins each other.

Styrene resins, (meth)acrylic resins, and styrene-(meth)acrylic copolymer resins are obtained, for example, by combining styrene monomers and (meth)acrylic acid monomers singly or in a combination of two or more types through a known method. “(Meth)acrylic” is an expression including both of “acrylic” and “methacrylic”.

The polyester resins are synthesized by selecting and combining preferable components from among dicarboxylic acid components and diol components using, for example, a known method such as an ester exchange method or a polycondensation method.

When the styrene resins, the (meth)acrylic resins, and the copolymer resins thereof are used as a binder resin, preferably a weight average molecular weight Mw thereof is from 20,000 to 100,000, and a number average molecular weight Mn thereof is from 2,000 to 30,000. On the other hand, when polyester resins are used as a binder resin, preferably a weight average molecular weight Mw thereof is from 5,000 to 40,000, and a number average molecular weight Mn thereof is from 2,000 to 10,000.

The glass transition temperature of the binder resin is preferably from 40° C. to 80° C. When the glass transition temperature is in the above range, the minimum fixing temperature is easily maintained.

The colorant is not particularly limited as long as it is a known colorant. Examples thereof include carbon blacks such as furnace black, channel black, acetylene black, and thermal black, inorganic pigments such as red iron oxide, iron blue, and titanium oxide, azo pigments such as fast yellow, disazo yellow, pyrazolone red, chelate red, brilliant carmine, and para brown, phthalocyanine pigments such as copper phthalocyanine and metal-free phthalocyanine, and condensed polycyclic pigments such as flavanthrone yellow, dibromoanthrone orange, perylene red, quinacridone red, and dioxazine violet.

If necessary, the colorant may be surface-treated, or may be used in combination with a dispersant. Plural types of colorants may be used in combination.

The content of the colorant is preferably from 1% by weight to 30% by weight with respect to the total weight of the binder resin.

Examples of the release agent include, but are not limited to, hydrocarbon waxes; natural waxes such as carnauba wax, rice wax, and candelilla wax; synthetic, or mineral or petroleum waxes such as montan wax; and ester waxes such as fatty acid esters and montanate esters.

The melting temperature of the release agent is preferably 50° C. or higher, and more preferably 60° C. or higher from the viewpoint of preservability. In addition, the melting temperature is preferably 110° C. or lower, and more preferably 100° C. or lower from the viewpoint of an offset-resistance property.

The content of the release agent is preferably from 1% by weight to 15% by weight, more preferably from 2% by weight to 12% by weight, and even more preferably from 3% by weight to 10% by weight with respect to the total weight of the binder resin.

Examples of other additives include magnetic materials, a charge-controlling agent, and inorganic powders.

The toner particles may have a shape factor SF1 of from 125 to 140 (preferably from 125 to 135, and more preferably from 130 to 135), and a shape factor SF2 of from 105 to 130 (preferably from 110 to 125, and more preferably from 115 to 120).

The shape factor SF1 of the toner particles is calculated with the following expression.

Shape Factor SF1=(ML²/A)×(π/4)×100 Expression:

In the expression, ML represents an absolute maximum length of the toner particle, and A represents a projected area of the toner particle.

The shape factor SF1 is quantified by primarily analyzing a microscopic image or a scanning electron microscopical (SEM) image using an image analyzer, and calculated for example as follows. That is, an optical microscopic image of the toner particles sprayed on a surface of a glass slide is taken in a Luzex image analyzer through a video camera, maximum lengths and projected areas of 100 toner particles are calculated, a SF1 of each toner particle is calculated with the above expression, and an average value thereof is calculated to obtain the shape factor SF1.

The shape factor SF2 of the toner particles is calculated as follows.

An image is photographed while observing the toner particles using a scanning electron microscope (for example, manufactured by Hitachi Ltd.: S-4100). This image is taken in an image analyzer (for example, LUZEX III, manufactured by Nireco Corporation), and SF2 of each of 100 toner particles is calculated on the basis of the following expression to calculate an average value thereof. The average value is defined as the shape factor SF2. The magnification of the electron microscope is adjusted so that approximately from 3 to 20 external additive particles are photographed in one field of vision, and SF2 is calculated on the basis of the following expression by combining the observations in more than one field of vision.

Shape Factor SF2=“PM²/(4·A·π)”×100 Expression:

Here, in the expression, PM represents a boundary length of the toner particle. A represents a projected area of the toner particle. π represents a circular constant.

The volume average particle size of the toner particles is preferably from 2 μm to 10 μm, and more preferably from 4 μm to 8 μm.

The volume average particle size of the toner particles is measured using a Coulter Multisizer II (manufactured by Beckman Coulter, Inc.) with an aperture diameter of 50 μm. At this time, the measurement is performed after the toner particles are dispersed in an electrolyte aqueous solution (Isoton aqueous solution) for at least 30 seconds by ultrasonic waves.

Regarding a measurement method, from 0.5 mg to 50 mg of a measurement sample is added to 2 ml of a 5% aqueous solution of a surfactant, preferably sodium alkylbenzene sulfonate as a dispersant, and this mixture is added to from 100 ml to 150 ml of the electrolyte. The electrolyte containing the measurement sample suspended therein is subjected to a dispersion treatment by an ultrasonic disperser for 1 minute, and a particle size distribution of particles is measured. The number of the particles to be measured is 50,000.

Regarding the volume, a cumulative distribution is drawn from the small diameter side with respect to particle size ranges (channels) divided on the basis of the measured particle size distribution. A particle size at an accumulation of 50% is defined as a volume average particle size.

External Additive

Silica composite particles are applied as an external additive.

Silica Composite Particles

The silica composite particles are composite particles in which silicon oxide (silicon dioxide: silica) and titanium are mixed, in other words, composite particles in which titanium is present and dispersed in particles configured of silicon oxide.

The content of titanium in all of the silica composite particles is from 0.001% by weight to 10% by weight, preferably from 0.01% by weight to 9% by weight, and more preferably from 0.1% by weight to 5% by weight.

When the content of titanium is less than 0.001% by weight, the charge exchangeability of the toner is difficult to improve, and thus transferability is reduced and fogging occurs. In addition, the silica composite particles separate out from the toner particles and image density fluctuation thus occurs.

On the other hand, when the content of titanium is greater than 10% by weight, an organic titanium compound (particularly, tetraalkoxy titanium) vigorously reacts during the preparation of the silica composite particles, and thus excessively coarse particles are generated, and deterioration in particle size distribution and shape occurs, whereby, a target particle size may not be obtained, and particularly, when the silica composite particles are mechanically loaded, defects are easily generated and fluidity is difficult to improve. In addition, the silica composite particles separate out from the toner particles and image density fluctuation thus easily occurs.

The content of titanium is measured as follows. First, the silica composite particles are separated from the toner. Regarding the separated silica composite particles, the NET intensity of the constituent element in the particles is calculated using a fluorescent X-ray analyzer XRF 1500 (manufactured by Shimadzu Corporation), and the content of titanium is quantified with this NET intensity and a calibration curve of the NET intensity from 0% to 100% of titanium.

Average Particle Size

The average particle size of the silica composite particles is from 30 nm to 500 nm, preferably from 60 nm to 500 nm, more preferably from 100 nm to 350 nm, and even more preferably from 100 nm to 250 nm.

The average particle size is an average particle size of primary particles of the silica composite particles.

When the average particle size of the silica composite particles is less than 30 nm, the shape of the silica composite particles becomes spherical easily, whereby it is difficult for the average circularity of the silica composite particles to be from 0.50 to 0.85, and thus even when the silica composite particles have an irregular shape, embedding of the silica composite particles into the toner particles is not easily suppressed and fluidity of the toner is difficult to realize. Therefore, a function as a spacer is lost and transferability is easily reduced.

On the other hand, when the average particle size of the silica composite particles is greater than 500 nm, defects are easily generated when the silica composite particles are mechanically loaded, and thus fluidity of the toner is difficult to realize. In addition, the silica composite particles separate out from the toner particles and image density fluctuation thus easily occurs.

The average particle size of the silica composite particles means a 50% diameter (D50v) in the cumulative frequency of the equivalent circle diameters obtained by observing 100 primary particles after external addition of the silica composite particles to the toner particles using a scanning electron microscope (SEM) device and by analyzing the image of the primary particles.

Particle Size Distribution Index

The silica composite particles have a particle size distribution index of from 1.1 to 1.5 and preferably from 1.25 to 1.40.

The particle size distribution index is a particle size distribution index of primary particles of the silica composite particles.

Silica particles in which the particle size distribution index of silica composite particles is less than 1.1 are not easily manufactured.

When the particle size distribution of the silica composite particles is greater than 1.5, dispersibility to the toner particles deteriorates due to the generation of coarse particles and a variation in the particle size. In addition, together with an increase in number of coarse particles, the number of defective particles also increase due to the mechanical load thereof, and thus the fluidity of the toner is difficult to realize. The silica composite particles separate out from the toner particles and image density fluctuation thus easily occurs.

The particle size distribution index of the silica composite particles means a square root of the value obtained by dividing a 84% diameter by a 16% diameter in the cumulative frequency of the equivalent circle diameters obtained by observing 100 primary particles after distribution of the silica composite particles in the toner particles using a SEM device and by analyzing the image of the primary particles.

Average Circularity

The average circularity of primary particles of the silica composite particles is from 0.5 to 0.85 (preferably from 0.6 to 0.8).

The average circularity is an average circularity of primary particles of the silica composite particles.

When the average circularity of the silica composite particles is less than 0.50, the silica composite particles have a spherical shape having a high aspect ratio, and thus when the silica composite particles are mechanically loaded, the stress is concentrated, whereby defects are easily generated and fluidity of the toner is difficult to realize.

On the other hand, when the average circularity of the silica composite particles is greater than 0.85, the silica composite particles have a shape close to a spherical shape. Therefore, the silica composite particles are unevenly distributed and adhered due to the mechanical load of the stirring during the mixing with the toner particles, or unevenly distributed and adhered after preservation for a period of time. Accordingly, dispersibility to the toner particles deteriorates and the contact area between the toner particles and the silica particles is reduced, and thus the silica composite particles easily separate out from the toner particles and image density fluctuation thus easily occurs.

The circularity “100/SF2” of the silica composite particles is calculated with the following expression by observing the primary particles after external addition of the silica composite particles to the toner particles using a SEM device and by analyzing the obtained image of the primary particles.

Circularity (100/SF2)=4π×(A/I²) Expression:

In the expression, I represents a boundary length of the primary particle on the image. A represents a projected area of the primary particle.

The average circularity of the silica composite particles is obtained as a 50% circularity in the cumulative frequency of the equivalent circle diameters of the 100 primary particles obtained by the above-described image analysis.

Silica Composite Particle Manufacturing Method

The silica composite particles are, for example, manufactured using the following method (hereinafter, “silica composite particle manufacturing method”).

The silica composite particle manufacturing method has a step of preparing an alkali catalyst solution containing an alkali catalyst at a concentration of from 0.6 mol/L to 0.85 mol/L in an alcohol-containing solvent, and a step of supplying, to the alkali catalyst solution, a mixture of a tetraalkoxysilane and an organic titanium compound with an organic group bonded to a titanium atom via oxygen at a feed rate of from 0.001 mol/(mol·min) to 0.01 mol/(mol·min) with respect to alcohol, and supplying from 0.1 mol to 0.4 mol of an alkali catalyst per 1 mol of a total supply amount of the tetraalkoxysilane and the organic titanium compound to be supplied per minute.

Hereinafter, “mixture of a tetraalkoxysilane and an organic titanium compound” will be collectively referred to as “organometallic mixture”, and “tetraalkoxysilane and an organic titanium compound” will be collectively referred to as “organometallic compounds”.

That is, in the silica composite particle manufacturing method, in the presence of alcohol containing an alkali catalyst at the above-described concentration, an organometallic mixture that is a raw material and an alkali catalyst that is a catalyst are separately supplied to satisfy the above-described relationship, and organometallic compounds are respectively reacted, thereby generating silica composite particles.

In the silica composite particle manufacturing method, only a small amount of coarse aggregates is generated and silica composite particles having an irregular shape are obtained by the above technique. The reason for this is not clear, but it is thought that this is due to the following reasons.

First, when an alkali catalyst solution containing an alkali catalyst in an alcohol-containing solvent is prepared and an organometallic mixture and an alkali catalyst are respectively supplied to the solution, the organometallic compounds supplied to the alkali catalyst solution are respectively reacted and core particles are thus generated. At this time, when the concentration of the alkali catalyst in the alkali catalyst solution is in the above range, it is thought that generation of coarse aggregates such as secondary aggregates is suppressed and core particles having an irregular shape are generated. It is thought that the reason for this is that as well as performing catalysis, the alkali catalyst is coordinated to the surface of the generated core particles to contribute to the shape of the core particles and dispersion stability, but when the amount of the alkali catalyst is in the above range, unevenness occurs during the covering of the surface of the core particles with the alkali catalyst that is, the alkali catalyst is unevenly distributed and adhered to the surface of the core particles), and thus the distribution stability of the core particles is maintained, but a partial bias is generated in the surface tension and the chemical affinity of the core particles and core particles having an irregular shape are generated.

In addition, when the organometallic mixture and the alkali catalyst are continuously supplied, the generated core particles grow by the respective reactions of the organometallic compounds, and silica composite particles are obtained.

It is thought that when the organometallic mixture and the alkali catalyst are supplied while maintaining the supply amounts thereof to satisfy the above-described relationship, generation of coarse aggregates such as secondary aggregates is suppressed, the core particles having an irregular shape grow while maintaining the irregular shape thereof, and as a result, silica composite particles having an irregular shape are generated. It is thought that the reason for this is that when the supply amounts of the organometallic mixture and the alkali catalyst satisfy the above-described relationship, dispersion of the core particles is maintained and a partial bias in the surface tension and the chemical affinity of the core particles is maintained, and thus the core particles grow while maintaining the irregular shape.

Here, it is thought that the supply amount of the organometallic mixture relates to the particle size distribution and the circularity of the silica composite particles. When the supply amount of the organometallic mixture is from 0.001 mol/(mol·min) to 0.01 mol/(mol·min) with respect to the alcohol, the contact probability between the dripped tetraalkoxysilane and the core particles is reduced, and thus it is thought that the organometallic compounds are supplied to the core particles without bias before the reaction of the organometallic compounds with each other. Accordingly, it is thought that the organometallic compounds maybe reacted with the core particles without bias. As a result, it is thought that a variation in the particle growth is suppressed and silica composite particles having a narrow distribution width may be manufactured.

It is thought that the average particle size of the silica composite particles depends on the total supply amount of the organometallic compounds.

From the above description, it is thought that the silica composite particles may be obtained with the silica composite particle manufacturing method.

In addition, since it is thought that in the silica composite particle manufacturing method, core particles having an irregular shape are generated and are grown while maintaining the irregular shape thereof, and thus silica composite particles are generated, it is thought that silica composite particles having an irregular shape with high shape stability with respect to a mechanical load may be obtained.

In addition, since it is thought that in the silica composite particle manufacturing method, the generated core particles having an irregular shape grow while maintaining the irregular shape, and thus silica composite particles may be obtained, it is thought that silica composite particles that are highly resistant to a mechanical load and are thus not easily broken may be obtained.

In addition, in the silica composite particle manufacturing method, since an organometallic mixture and an alkali catalyst are respectively supplied to an alkali catalyst solution to react organometallic compounds, respectively, to thereby generate particles, a total amount of the alkali catalyst used is smaller than in the case of manufacturing silica composite particles having an irregular shape by a conventional sol-gel method, and as a result, an alkali catalyst removing step is omitted. This is particularly favorable when the silica composite particles are applied to a product that is required to have a high purity.

First, an alkali catalyst solution preparation step will be described.

In the alkali catalyst solution preparation step, an alcohol-containing solvent is prepared and an alkali catalyst is added thereto, thereby preparing an alkali catalyst solution.

The alcohol-containing solvent may be a single solvent of an alcohol, or if necessary, may be a mixed solvent with other solvents such as water, ketones such as acetone, methyl ethyl ketone, and methyl isobutyl ketone, cellosolves such as methyl cellosolve, ethyl cellosolve, butyl cellosolve, and cellosolve acetate, and ethers such as dioxane and tetrahydrofuran. In the case of a mixed solvent, the amount of alcohol with respect to other solvents is preferably 80% by weight or greater and more preferably 90% by weight or greater.

Examples of the alcohol include lower alcohols such as methanol and ethanol.

The alkali catalyst is a catalyst for promoting the reactions of the organometallic compounds (hydrolysis reaction and condensation reaction). Examples thereof include basic catalysts such as ammonia, urea, a monoamine, and a quaternary ammonium salt, and particularly, ammonia is preferable.

The concentration (content) of the alkali catalyst is from 0.6 mol/L to 0.85 mol/L, preferably from 0.63 mol/L to 0.78 mol/L, and more preferably from 0.66 mol/L to 0.75 mol/L.

When the concentration of the alkali catalyst is lower than 0.6 mol/L, the dispersibility of the core particles in the course of growth of the generated core particles becomes unstable, and thus coarse aggregates such as secondary aggregates are generated or gelation proceeds, whereby the particle size distribution may deteriorate.

On the other hand, when the concentration of the alkali catalyst is higher than 0.85 mol/L, stability of the generated core particles becomes excessive, and thus core particles having a complete spherical shape are generated, core particles having an irregular shape with an average circularity of 0.85 or less are not obtained, and as a result, silica composite particles having an irregular shape are not obtained.

The concentration of the alkali catalyst is a concentration based on the alcohol catalyst solution (solvent containing the alkali catalyst and alcohol).

Next, a particle generation step will be described.

In the particle generation step, an organometallic mixture and an alkali catalyst are respectively supplied to the alkali catalyst solution, and organometallic compounds are respectively reacted in the alkali catalyst solution (hydrolysis reaction and condensation reaction) to generate silica composite particles.

In the particle generation step, at the initial time of supplying the organometallic mixture, core particles are generated by the respective reactions of the organometallic compounds (core particle generation stage), and through the growth of the core particles (core particle growth stage), silica composite particles are generated.

In the organometallic compounds (mixture of a tetraalkoxysilane and an organic titanium compound) that are supplied to the alkali catalyst solution, a ratio between the tetraalkoxysilane and the organic titanium compound (tetraalkoxysilane/organic titanium compound) is preferably from 9.0 to 99999, more preferably from 10.1 to 9999, and even more preferably from 19 to 999 in terms of weight ratio.

When the amount of the organic titanium compound is too small in the organometallic mixture, the content of the titanium in the silica composite particles is small, and when the amount of the organic titanium compound is too large, the content of the titanium in the silica composite particles is large.

Particularly, when the amount of the organic titanium compound is too large, the organic titanium compound vigorously reacts, and thus excessively coarse particles are generated and deterioration in particle size distribution and shape occurs, whereby a target particle size is not obtained. Particularly, when the obtained silica composite particles are mechanically loaded, defects are easily generated and fluidity is difficult to improve.

Examples of the tetraalkoxysilane include tetramethoxysilane, tetraethoxysilane, tetrapropoxysilane, and tetrabutoxysilane. Tetramethoxysilane and tetraethoxysilane are preferable in consideration of controllability of the reaction rate and the shape, particle size, and particle size distribution of silica composite particles to be obtained, and the like.

The organic titanium compound is an organometallic compound with an organic group bonded to a titanium atom via oxygen, and examples thereof include oroanic titanium compounds of alkoxides (such as methoxide, ethoxide, n-propoxide, i-propoxide, n-butoxide, i-butoxide, sec-butoxide, and tert-butoxide), chelates, or acylates (such as β-diketones such as acetylacetonato; β-ketoesters such as ethyl acetoacetate; amines such as triethanolamine; and carboxylic acids such as acetic acid, butyric acid, lactic acid, and citric acid).

However, the organic titanium compound is preferably an organic titanium compound having one or more (preferably two or more) alkoxy groups in consideration of controllability of the reaction rate and the shape, particle size, and particle size distribution of silica composite particles to be obtained, and the like. That is, the organic titanium compound is preferably an organic titanium compound with one or more (preferably two or more) alkoxy groups (alkyl groups bonded to a titanium atom via oxygen) bonded to a titanium atom.

The number of carbon atoms of the alkoxy group is preferably 8 or less, and more preferably from 3 to 8 in consideration of controllability of the reaction rate and the shape, particle size, and particle size distribution of silica composite particles to be obtained, and the like.

Specific examples of the organic titanium compound include tetra-i-propoxytitanium, tetra-n-butoxytitanium, tetra-t-butoxytitanium, di-i-propoxy bis(ethylacetoacetate)titanium, di-i-propoxy bis(acetylacetonato)titanium, di-i-propoxy bis(triethanolaminate)titanium, di-i-propoxy titanium diacetate, and di-i-propoxy titanium dipropionate.

The supply amount of the organometallic mixture is from 0.001 mol/(mol·min) to 0.01 mol/(mol·min), preferably from 0.002 mol/(mol·min) to 0.009 mol/(mol·min), and more preferably from 0.003 mol/(mol·min) to 0.008 mol/(mol·min) with respect to the alcohol in the alkali catalyst solution.

This means that from 0.001 mol to 0.01 mol of the organometallic compounds are supplied per minute with respect to 1 mol of the alcohol used in the alkali catalyst solution preparation step.

Regarding the particle size of the silica composite particles, though it also depends on the types of the organometallic compounds and the reaction conditions, when the total supply amount of the organometallic compounds that are used in the particle generation reaction is, for example, 1.08 mol or greater with respect to 1 L of the silica composite particle dispersion, primary particles having a particle size of 100 nm or greater are obtained, and when the total supply amount of the organometallic compounds is 5.49 mol or less with respect to 1 L of the silica composite particle dispersion, primary particles having a particle size of 500 nm or less are obtained.

When the supply amount of the organometallic mixture is less than 0.001 mol/(mol·min), the contact probability between the dripped organometallic compound and the core particles is further reduced. However, a long time is required until dripping of the total supply amount of tetraalkoxysilane ends, and the production efficiency is low.

When the supply amount of the organometallic mixture is greater than 0.01 mol/(mol·min), it is thought that the organometallic compounds react with each other before the reaction of the dripped organometallic compound with the core particles. Therefore, uneven distribution of the organometallic compounds to the core particles is promoted and a variation is caused in the formation of the core particles, whereby the average particle size and the distribution width of the shape distribution are expanded.

The alkali catalyst that is supplied to the alkali catalyst solution is exemplified as described above. The alkali catalyst to be supplied may be the same type as, or a different type from the alkali catalyst that is contained in the alkali catalyst solution in advance. However, the same type may be preferably used.

The supply amount of the alkali catalyst is from 0.1 mol to 0.4 mol, preferably from 0.14 mol to 0.35 mol, and more preferably from 0.18 mol to 0.30 mol per 1 mol of a total supply amount of the organometallic compounds (total supply amount of the tetraalkoxysilane and the organic titanium compound) to be supplied per minute.

When the supply amount of the alkali catalyst is less than 0.1 mol, the dispersibility of the core particles in the course of growth of the generated core particles becomes unstable, and thus coarse aggregates such as secondary aggregates are generated or gelation proceeds, whereby the particle size distribution may deteriorate.

On the other hand, when the supply amount of the alkali catalyst is greater than 0.4 mol, stability of the generated core particles becomes excessive, and thus even when core particles having an irregular shape are generated in the core particle generation stage, the core particles grow into a spherical shape in the core particle growth stage, and silica composite particles having an irregular shape may not be obtained. Therefore, the silica composite particles are difficult to adhere to the toner particles. As a result, image density fluctuation easily occurs.

Here, in the particle generation step, the organometallic mixture and the alkali catalyst are respectively supplied to the alkali catalyst solution. However, in this supply method, the organometallic mixture and the alkali catalyst may be continuously or intermittently supplied.

In addition, in the particle generation step, the temperature of the alkali catalyst solution (temperature at the time of supply) is, for example, preferably from 5° C. to 50° C., and more preferably from 15° C. to 40° C.

Through the above steps, silica composite particles are obtained. In this state, the obtained silica composite particles are in a dispersion state. However, the silica composite particles may be directly used as the silica composite particle dispersion, or may be obtained and used as a powder of the silica composite particles by removing the solvent.

When the silica composite particles are used as a silica composite particle dispersion, the concentration of the solid content of the silica composite particles may be adjusted by dilution with water or an alcohol or concentration. In the silica composite particle dispersion, the solvent may be substituted with a solvent, e.g., a water-soluble organic solvent such as other alcohols, esters and ketones.

On the other hand, when the silica composite particles are used as a powder of the silica composite particles, it is necessary to remove the solvent from the silica composite particle dispersion. As a solvent removing method, known methods such as 1) a method including: removing a solvent by filtration, centrifugal separation, distillation or the like; and drying using a vacuum dryer, a tray dryer or the like, and 2) a method of directly drying a slurry using a fluidized bed dryer, a spray dryer, or the like are exemplified. The drying temperature is not particularly limited, but is preferably 200° C. or lower. When the drying temperature is higher than 200° C., the primary particles are easily bonded to each other due to the condensation of the silanol groups remaining on the surface of the silica composite particles, or coarse particles are easily generated.

If necessary, the dried silica composite particles are preferably pulverized or sieved to remove coarse particles or aggregates. The pulverizing method is not particularly limited, and performed using, for example, a dry pulverizer such as a jet mill, a vibration mill, a ball mill, or a pin mill. The sieving method is performed by a known vibration sieve, wind power sieving machine, or the like.

The silica composite particles that are obtained by the silica composite particle manufacturing method may be used after subjecting the surface of the silica composite particles to a hydrophobizing treatment with a hydrophobizing agent.

Examples of the hydrophobizing agent include known organic silicon compounds having an alkyl group (for example, a methyl group, an ethyl group, a propyl group, and a butyl group), and specific examples thereof include silazane compounds (for example, silane compounds such as methyltrimethoxysilane, dimethyldimethoxysilane, trimethylchlorosilane, and trimethylmethoxysilane, hexamethyldisilazane, and tetramethyldisilazane). As the hydrophobizing agent, one or two or more types may be used.

Among these hydrophobizing agents, organic silicon compounds having a trimethyl group, such as trimethylmethoxysilane and hexamethyldisilazane are preferable.

The amount of the hydrophobizing agent to be used is not particularly limited. However, in order to obtain an effect of hydrophobization, the amount is, for example, from 1% by weight to 100% by weight, and preferably from 5% by weight to 80% by weight with respect to the silica composite particles.

Examples of the method of obtaining a hydrophobic silica composite particle dispersion subjected to a hydrophobizing treatment with a hydrophobizing agent include a method of obtaining a hydrophobic silica composite particle dispersion, in which a necessary amount of a hydrophobizing agent is added to a silica composite particle dispersion to conduct a reaction at a temperature of from 30° C. to 80° C. during stirring to thereby subject silica composite particles to a hydrophobizing treatment. When the reaction temperature is lower than 30° C., the hydrophobizing reaction does not easily proceed, and when the reaction temperature is higher than 80° C., gelation of the dispersion or aggregation of the silica composite particles due to the self condensation of the hydrophobizing agent may easily occur.

Examples of the method of obtaining a powder of hydrophobic silica composite particles include a method in which a hydrophobic silica composite particle dispersion is obtained using the above-described method, and then dried using the above-described method, thereby obtaining a powder of hydrophobic silica composite particles, a method in which a powder of hydrophilic silica composite particles is obtained by drying a silica composite particle dispersion, and then a hydrophobizing agent is added thereto to perform a hydrophobizing treatment, thereby obtaining a powder of hydrophobic silica composite particles, and a method in which a hydrophobic silica composite particle dispersion is obtained and then dried to obtain a powder of hydrophobic silica composite particles, and then a hydrophobizing agent is added thereto to perform a hydrophobizing treatment, thereby obtaining a powder of hydrophobic silica composite particles.

Here, examples of the method of subjecting a powder of silica composite particles to a hydrophobizing treatment include a method in which a powder of hydrophilic silica composite particles is stirred in a treatment tank such as a Henschel mixer or a fluid bed, a hydrophobizing agent is added thereto, and the inside of the treatment tank is heated to gasify the hydrophobizing agent, thereby conducting a reaction with a silanol group of the surface of the powder of silica composite particles. The treatment temperature is not particularly limited, but is, for example, preferably from 80° C. to 300° C., and more preferably from 120° C. to 200° C.

The above-described silica composite particles as an external additive are added in an amount of preferably from 0.5 part by weight to 5.0 parts by weight, more preferably from 0.7 part by weight to 4.0 parts by weight, and even more preferably from 0.9 part by weight to 3.5 parts by weight with respect to 100 parts by weight of the toner particles.

Toner Manufacturing Method

Next, a method of manufacturing the toner according to this exemplary embodiment will be described.

The toner according to this exemplary embodiment is obtained by manufacturing toner particles and subsequently externally adding silica composite particles as an external additive to the toner particles.

The toner particles are preferably manufactured by a wet granulation method. Examples of the wet granulation method include a melting and suspension method, an emulsification, aggregation, and coalescence method, and a dissolution and suspension method, that have been known.

Examples of the method of externally adding silica composite particles to the obtained toner particles include a method of performing mixing by a known mixer such as a V-blender, a Henschel mixer, or a Lodige mixer.

Electrostatic Charge Image Developer

An electrostatic charge image developer contains at least the toner according to this exemplary embodiment.

The electrostatic charge image developer may be a single-component developer containing only the toner according to this exemplary embodiment, or a two-component developer in which the toner and a carrier are mixed.

The carrier is not particularly limited, and known carriers are exemplified. Examples of the carrier include resin-coated carriers, magnetic dispersion-type carriers, and resin dispersion-type carriers.

The mixing ratio (weight ratio) between the toner according to this exemplary embodiment and the carrier in the two-component developer is preferably approximately from 1:100 to 30:100, and more preferably approximately from 3:100 to 20:100 (toner:carrier).

Image Forming Apparatus and Image Forming Method

Next, an image forming apparatus and an image forming method according to this exemplary embodiment using the toner according to this exemplary embodiment will be described.

The image forming apparatus is configured to be provided with an electrostatic latent image holding member, a charging unit that charges a surface of the electrostatic latent image holding member, an electrostatic latent image forming unit that forms an electrostatic latent image on a charged surface of the electrostatic latent image holding member, a developing unit that accommodates the electrostatic charge image developer according to this exemplary embodiment and develops the electrostatic latent image formed on the surface of the electrostatic latent image holding member with the electrostatic charge image developer to form a toner image, a transfer unit that transfers the toner image onto a recording medium, and a fixing unit that fixes the toner image to the recording medium.

According to the image forming apparatus, an image forming method having a charging step of charging a surface of an electrostatic latent image holding member, an electrostatic latent image forming step of forming an electrostatic latent image on a charged surface of the electrostatic latent image holding member, a developing step of developing the electrostatic latent image formed on the surface of the electrostatic latent image holding member with the electrostatic charge image developer according to this exemplary embodiment to form a toner image, a transfer step of transferring the toner image onto a recording medium, and a fixing step of fixing the toner image to the recording medium is performed.

The image formation in the image forming apparatus is, for example, performed as follows when an electrophotographic photoreceptor is used as an electrostatic latent image holding member. First, a surface of an electrophotographic photoreceptor is charged by a corotron charger, a contact charger, or the like, and then subjected to exposure to form an electrostatic charge image. Next, a developing roll having a developer layer formed on the surface thereof is brought into contact with or close proximity to the surface of the photoreceptor to adhere a toner to the electrostatic latent image and form a toner image on the electrophotographic photoreceptor. The formed toner image is transferred onto a surface of a recording medium such as paper using a corotron charger or the like. Furthermore, the toner image transferred onto the surface of the recording medium is fixed by a fixing machine to form an image on the recording medium. In addition, when the image forming apparatus is provided with a cleaning unit, the surface of the electrostatic latent image holding member is cleaned by a cleaning blade after the transfer of the toner image, and then recharged.

In the image forming apparatus, for example, a part including the developing unit may have a cartridge structure (toner cartridge, process cartridge, or the like) that is detachable from the image forming apparatus.

As the toner cartridge, for example, a toner cartridge that accommodates the toner according to this exemplary embodiment and is detachable from the image forming apparatus is preferably used.

As the process cartridge, a process cartridge that is provided with a developing unit that accommodates the electrostatic charge image developer according to this exemplary embodiment and develops an electrostatic latent image formed on a surface of an electrostatic latent image holding member with the electrostatic charge image developer to form a toner image, and is detachable from the image forming apparatus is preferably used.

Hereinafter, an example of the image forming apparatus of this exemplary embodiment will be shown. However, the image forming apparatus is not limited thereto. Major parts shown in the drawings will be described, but descriptions of other parts will be omitted.

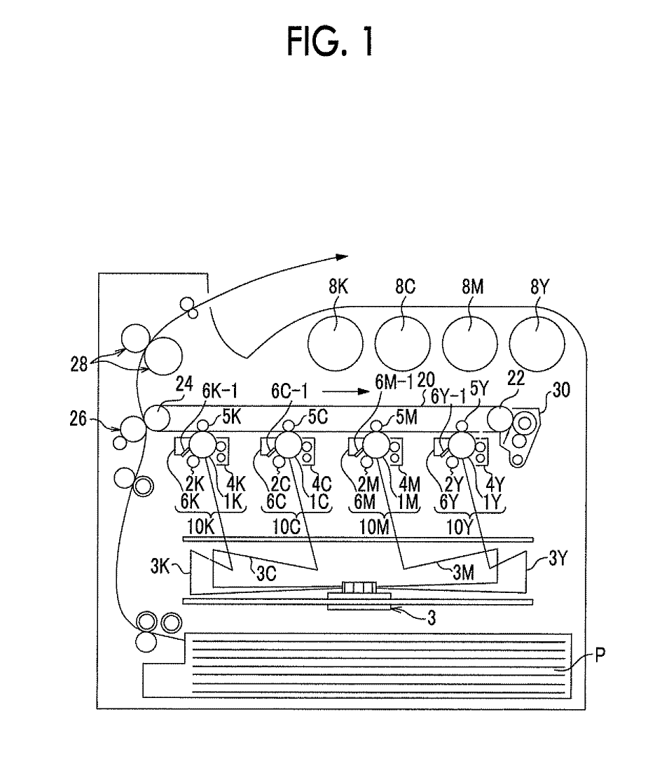

FIG. 1 is a schematic diagram showing a configuration of a four-drum tandem-type color image forming apparatus. The image forming apparatus shown in FIG. 1 is provided with first to fourth electrophotographic image forming units 10Y, 10M, 10C, and 10K (image forming units) that output yellow (Y), magenta (M), cyan (C), and black (K) images based on color-separated image data. These image forming units (hereinafter, may be simply referred to as “units”) 10Y, 10M, 10C, and 10K are arranged side by side at predetermined intervals. These units 10Y, 10M, 10C, and 10K may be process cartridges that are detachable from the body of the image forming apparatus.

An intermediate transfer belt 20 as an intermediate transfer member is installed above the units 10Y, 10M, 10C, and 10K in the drawing to extend through the units. The intermediate transfer belt 20 is wound on a driving roller 22 and a support roller 24 contacting the inner surface of the intermediate transfer belt 20, which are separated from each other on the left and right sides in the drawing, and travels in a direction toward the fourth unit 10K from the first unit 10Y. The support roller 24 is pushed in a direction in which it departs from the driving roller 22 by a spring or the like (not shown), and a tension is given to the intermediate transfer belt 20 wound on both of the rollers. In addition, an intermediate transfer member cleaning device 30 opposed to the driving roller 22 is provided on a surface of the intermediate transfer belt 20 on the image holding member side.

Developing devices (developing units) 4Y, 4M, 4C, and 4K of the units 10Y, 10M, 10C, and 10K may be supplied with toners including four color toners, that is, a yellow toner, a magenta toner, a cyan toner, and a black toner accommodated in toner cartridges 8Y, 8M, 8C, and 8K, respectively.

The above-described first to fourth units 10Y, 10M, 10C, and 10K have the same configuration. Here, only the first unit 10Y that is disposed on the upstream side in a traveling direction of the intermediate transfer belt to form a yellow image will be representatively described. The same parts as in the first unit 10Y will be denoted by the reference numerals with magenta (M), cyan (C), and black (K) added instead of yellow (Y), and descriptions of the second to fourth units 10M, 10C, and 10K will be omitted.

The first unit 10Y has a photoreceptor 1Y acting as an electrostatic latent image holding member. Around the photoreceptor 1Y, a charging roller 2Y that charges a surface of the photoreceptor 1Y to a predetermined potential, an exposure device (electrostatic latent image forming unit) 3 that exposes the charged surface with laser beams 3Y based on a color-separated image signal to form an electrostatic latent image, a developing device (developing unit) 4Y that supplies a charged toner to the electrostatic latent image to develop the electrostatic latent image, a primary transfer roller (primary transfer unit) 5Y that transfers the developed toner image onto the intermediate transfer belt 20, and a photoreceptor cleaning device (cleaning unit) 6Y having a cleaning blade 6Y-1 that removes the toner remaining on the surface of the photoreceptor 1Y after primary transfer, are arranged in sequence.

The primary transfer roller 5Y is disposed inside the intermediate transfer belt 20 to be provided at a position opposed to the photoreceptor 1Y. Furthermore, bias supplies (not shown) that apply a primary transfer bias are connected to the primary transfer rollers 5Y, 5M, 5C, and 5K, respectively. The bias supplies change the transfer bias that is applied to each primary transfer roller under the control of a controller (not shown).

Hereinafter, an operation of forming a yellow image in the first unit 10Y will be described. First, before the operation, the surface of the photoreceptor 1Y is charged to a potential of approximately from −600 V to −800 V by the charging roller 2Y.

The photoreceptor 1Y is formed by stacking a photosensitive layer on a conductive substrate (volume resistivity at 20° C.: 1×10⁻⁶ Ωcm or less). The photosensitive layer typically has high resistance (that is about the same as the resistance of a general resin), but has a property in which when laser beams 3Y are applied, the specific resistance of apart irradiated with the laser beams changes. Accordingly, the laser beams 3Y are output to the surface of the charged photoreceptor 1Y via the exposure device 3 in accordance with image data for yellow sent from the controller (not shown). The laser beams 3Y are applied to the photosensitive layer on the surface of the photoreceptor 1Y, whereby an electrostatic latent image of a yellow print pattern is formed on the surface of the photoreceptor 1Y.

The electrostatic latent image is an image that is formed on the surface of the photoreceptor 1Y by charging, and is a so-called negative latent image, that is formed by applying the laser beams 3Y to the photosensitive layer so that the specific resistance of the irradiated part is lowered to cause charges to flow on the surface of the photoreceptor 1Y, while charges stay on a part to which the laser beams 3Y are not applied.

The electrostatic latent image that is formed in this manner on the photoreceptor 1Y is rotated up to a predetermined development position with the travelling of the photoreceptor 1Y. The electrostatic latent image on the photoreceptor 1Y is formed as a visual image (developed image) at the development position by the developing device 4Y.

The developing device 4Y accommodates, for example, an electrostatic charge image developer according to this exemplary embodiment including at least a yellow toner and a carrier. The yellow toner is frictionally charged by being stirred in the developing device 4Y to have a charge with the same polarity (negative polarity) as the charge that is on the photoreceptor 1Y, and is thus held on the developer roll (developer holding member). By allowing the surface of the photoreceptor 1Y to pass through the developing device 4Y, the yellow toner is electrostatically adhered to the erased latent image part on the surface of the photoreceptor 1Y, whereby the latent image is developed with the yellow toner. Next, the photoreceptor 1Y having the yellow toner image formed thereon travels at a predetermined rate and the toner image developed on the photoreceptor 1Y is transported to a predetermined primary transfer position.

When the yellow toner image on the photoreceptor 1Y is transported to the primary transfer position, a primary transfer bias is applied to the primary transfer roller 5Y and an electrostatic force toward the primary transfer roller 5Y from the photoreceptor 1Y acts on the toner image, whereby the toner image on the photoreceptor 1Y is transferred onto the intermediate transfer belt 20. The transfer bias applied at this time has the opposite polarity (+) of the toner polarity (−), and is controlled to be, for example, approximately +10 μA in the first unit 10Y by the controller (not shown).

On the other hand, the toner remaining on the photoreceptor 1Y is removed and recovered by a cleaning blade 6Y-1 of the cleaning device 6Y.

The primary transfer biases that are applied to the primary transfer rollers 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 10C, and 10K, and the toner images of respective colors are multiply-transferred in a superimposed manner.

The intermediate transfer belt 20 onto which the four color toner images have been multiply-transferred through the first to fourth units reaches a secondary transfer part which is configured of the intermediate transfer belt 20, the support roller 24 contacting the inner surface of the intermediate transfer belt, and a secondary transfer roller (secondary transfer unit) 26 disposed on the image holding surface side of the intermediate transfer belt 20. Meanwhile, a recording sheet (recording medium) P is supplied to a gap between the secondary transfer roller 26 and the intermediate transfer belt 20, which are pressed against each other, via a supply mechanism at a predetermined timing, and a secondary transfer bias is applied to the support roller 24. The transfer bias applied at this time has the same polarity (−) as the toner polarity (−), and an electrostatic force toward the recording sheet P from the intermediate transfer belt 20 acts on the toner image, whereby the toner image on the intermediate transfer belt 20 is transferred onto the recording sheet P. In this case, the secondary transfer bias is determined depending on the resistance detected by a resistance detector (not shown) that detects the resistance of the secondary transfer part, and is voltage-controlled.

Thereafter, the recording sheet P that is a recording medium is fed to a pressure-contacting part (nip part) between a pair of fixing rolls in a fixing device (roll-shaped fixing unit) 28, and the toner image is heated. The color superimposed toner image is melted and fixed to the recording sheet P.

Examples of the recording medium onto which a toner image is transferred include plain paper that is used in electrophotographic copiers, printers, and the like and an OHP sheet.

The surface of the recording medium is preferably suppressed from being roughened as much as possible in order to suppress the image surface after fixing from being roughened. For example, coating paper obtained by coating a surface of plain paper with a resin or the like, art paper for printing, and the like are preferably used.

The recording sheet P on which the fixing of the color image is completed is discharged toward a discharge part, and a series of the color image forming operations ends.

The image forming apparatus exemplified as above has a configuration in which the toner image is transferred onto the recording sheet P via the intermediate transfer belt 20. However, the image forming apparatus is not limited to this configuration, and may be a known apparatus such as an apparatus in which the toner image is transferred directly onto the recording sheet from the photoreceptor.

Process Cartridge and Toner Cartridge

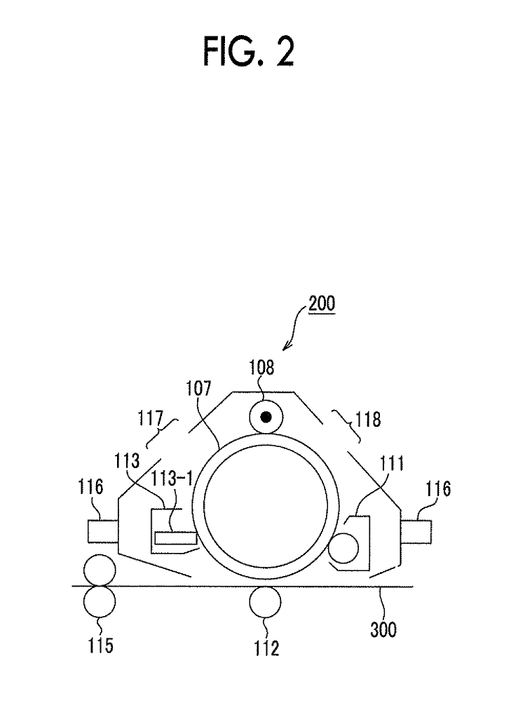

FIG. 2 is a schematic diagram showing a configuration of a preferable example of an exemplary embodiment of a process cartridge accommodating an electrostatic charge image developer. A process cartridge 200 has, in addition to a photoreceptor 107, a charging device 108, a developing device 111, a photoreceptor cleaning device 113 having a cleaning blade 113-1, an opening 118 for exposure, and an opening 117 for erasing exposure, and these are combined and integrated using an attachment rail 116. The reference numeral 300 in FIG. 2 denotes a recording medium.

The process cartridge 200 is detachable from an image forming apparatus configured of a transfer device 112, a fixing device 115, and other constituent parts (not shown).

The process cartridge 200 shown in FIG. 2 is provided with the charging device 108, the developing device 111, the cleaning device 113, the opening 118 for exposure, and the opening 117 for erasing exposure, but these devices may be selectively combined. The process cartridge is provided with, as well as the photoreceptor 107, at least one selected from the group consisting of the charging device 108, the developing device 111, the cleaning device (cleaning unit) 113, the opening 118 for exposure, and the opening 117 for erasing exposure.

Next, a toner cartridge will be described. The toner cartridge is a toner cartridge that accommodates an electrostatic charge image developing toner and is detachable from an image forming apparatus.

The image forming apparatus shown in FIG. 1 is an image forming apparatus that has a configuration in which the toner cartridges 8Y, 8M, 8C, and 8K are detachably mounted. The developing devices 4Y, 4M, 4C, and 4K are connected to the toner cartridges corresponding to the respective developing devices (colors) via toner supply tubes (not shown). In addition, when the toner accommodated in the toner cartridge runs low, the toner cartridge is replaced.

### EXAMPLES

Hereinafter, the exemplary embodiment will be described in detail using examples, but is not limited to the examples. In the following description, unless specifically noted, “parts” and “%” mean “parts by weight” and “%by weight”, respectively.

Preparation of Toner Particles

Toner Particles

Preparation of Polyester Resin Particle Dispersion

Ethylene Glycol (manufactured by Wako Pure Chemical Industries, Ltd.): 37 parts

Neopentyl Glycol (manufactured by Wako Pure Chemical Industries, Ltd.): 65 parts

1,9-Nonanediol (manufactured by Wako Pure Chemical Industries, Ltd.): 32 parts

Terephthalic Acid (manufactured by Wako Pure Chemical Industries, Ltd.): 96 parts

The above monomers are put into a flask, the temperature is increased to 200° C. over 1 hour, and after it is confirmed that the inside of the reaction system is stirred, 1.2 parts of dibutyltin oxide is added thereto. Furthermore, the temperature is increased from the foregoing temperature to 240° C. over 6 hours while distilling away formed water, and the dehydration condensation reaction is further continued at 240° C. for 4 hours, thereby obtaining a polyester resin A having an acid value of 9.4 mg KOH/g, a weight average molecular weight of 13,000, and a glass transition temperature of 62° C.

Next, the polyester resin A in a molten state is transferred into a CAVITRON CD1010 (manufactured by Eurotec. Co., Ltd.) at a rate of 100 parts per minute. Diluted ammonia water having a concentration of 0.37%, that is obtained by diluting reagent ammonia water with ion exchange water, is put into a separately prepared aqueous medium tank and transferred to the CAVITRON together with the molten polyester resin at a rate of 0.1 L per minute while being heated at 120° C. by a heat exchanger. The CAVITRON is operated under conditions of a rotor rotation rate of 60 Hz and a pressure of 5 kg/cm².

A polyester resin particle dispersion containing resin particles dispersed therein and having a volume average particle size of 160 nm, a solid content of 30%, a glass transition temperature of 62° C., and a weight average molecular weight Mw of 13,000 is obtained.

Preparation of Colorant Particle Dispersion

Cyan Pigment (C.I. Pigment Blue 15:3, manufactured by Dainichiseika Color & Chemicals Mfg. Co., Ltd.): 10 parts

Anionic surfactant (NEOGEN SC, manufactured by Dai-ichi Kogyo Seiyaku Co., Ltd.): 2 parts

Ion Exchange Water: 80 parts

The above components are mixed and dispersed by a high-pressure impact-type disperser ULTIMIZER (HJP30006, manufactured by Sugino Machine Limited) for 1 hour, thereby obtaining a colorant particle dispersion having a volume average particle size of 180 nm and a solid content of 20%.

Preparation of Release Agent Particle Dispersion

Carnauba Wax (RC-160, melting temperature: 84° C., manufactured by Toakasei Co., Ltd.): 50 parts

Anionic surfactant (NEOGEN SC, manufactured by Dai-ichi Kogyo Seiyaku Co., Ltd.): 2 parts

Ion Exchange Water: 200 parts

The above components are heated at 120° C., and mixed and dispersed using an ULTRA-TURRAX T50, manufactured by IKA-Werke GmbH & Co. KG. Then, the obtained dispersion is subjected to a dispersion treatment using a pressure discharge-type homogenizer, thereby obtaining a release agent particle dispersion having a volume average particle size of 200 nm and a solid content of 20%.

Preparation of Toner Particles

Polyester Resin Particle Dispersion: 200 parts

Colorant Particle Dispersion: 25 parts

Release Agent Particle Dispersion: 30 parts

Polyaluminum Chloride: 0.4 part

Ion Exchange Water: 100 parts

The above components are put into a stainless-steel flask, and mixed and dispersed using an ULTRA-TURRAX, manufactured by IKA-Werke GmbH & Co. KG. Thereafter, the obtained dispersion is heated to 48° C. in an oil bath for heating while stirring the flask. After holding at 48° C. for 30 minutes, 70 parts of the same polyester resin particle dispersion as that described above is added thereto.

Thereafter, after the pH in the system is adjusted to 8.0 using a sodium hydroxide aqueous solution having a concentration of 0. 5 mol/L, the stainless-steel flask is sealed, a seal of a stirring shaft is magnetically sealed, and heating to 90° C. is performed while continuing the stirring, followed by holding for 3 hours. After completion of the reaction, the obtained material is cooled at a rate of temperature decrease of 2° C./min, and filtered and then washed with ion exchange water. Then, solid-liquid separation is performed through Nutsche-type suction filtration. The obtained material is further redispersed using 3 L of ion exchange water at 30° C., and stirred and washed at 300 rpm for 15 minutes. This washing operation is further repeated six times, and when the filtrate has a pH of 7.54 and an electrical conductivity of 6.5 μS/cm, solid-liquid separation is performed through Nutsche-type suction filtration using No. 5A filter paper. Next, vacuum drying is continued for 12 hours, thereby obtaining toner particles.

A result of measuring a volume average particle size D50 v of the toner particles by a Coulter counter is 5.8 μm and a SF1 is 130.

Preparation of External Additive

Silica Composite Particles al

Alkali Catalyst Solution Preparation Step (Preparation of Alkali Catalyst Solution)

400 parts of methanol and 75 parts of 10% ammonia water (NH₄OH) are put into a glass reaction container having a volume of 2.5 L and equipped with a stirring blade, a dropping nozzle, and a thermometer, and are mixed by stirring to obtain an alkali catalyst solution. At this time, an ammonia catalyst amount, i.e., an NH₃ amount in the alkali catalyst solution (NH₃ (mol)/(NH₃+methanol+water) (L)) is 0.75 mol/L.

Particle Generation Step (Preparation of Silica Composite Particle Suspension)

First, 3.0% of tetrabutoxy titanium (TBT: tetra-t-butoxy titanium) is added to tetramethoxysilane (TMOS) to prepare an organometallic mixture.

Next, the temperature of the alkali catalyst solution is adjusted to 25° C., and the alkali catalyst solution is subjected to nitrogen purge. Thereafter, while the alkali catalyst solution is stirred at 120 rpm, dripping of 220 parts of the organometallic mixture and 174 parts of ammonia water (NH₄OH) having a catalyst (NH₃) concentration of 3.8% in the following supply amounts is started, and performed over 60 minutes, thereby obtaining a suspension of silica composite particles (silica composite particle suspension).

The supply amount of the organometallic mixture is adjusted to 0.0019 mol/(mol·min) with respect to a total number of moles of the methanol in the alkali catalyst solution.

In addition, the supply amount of the 3.8% ammonia water is adjusted to 0.27 mol/min with respect to 1 mol of a total supply amount of the organometallic compounds (tetraalkoxysilane and tetrabutoxy titanium) to be supplied per minute.

Thereafter, 300 parts of the solvent of the obtained silica composite particle suspension is distilled away by thermal distillation, and 300 parts of pure water is added. Then, the obtained material is dried by a freeze dryer, thereby obtaining a hydrophilic silica composite particle having an irregular shape.

Hydrophobizing treatment of Silica Composite Particles

Furthermore, 7 parts of hexamethyldisi]azane is added to 35 parts of the hydrophilic silica composite particles, and the mixture is reacted at 150° C. for 2 hours, thereby obtaining hydrophobic silica composite particles having an irregular shape in which the surface of the particles is subjected to a hydrophobizing treatment.

Silica Composite Particles a2 to a17 and b1 to b8

Silica composite particles a2 to a17 and b1 to b8 are obtained in the same manner as in the case of the silica composite particles a1, except that the conditions of the alkali catalyst solution preparation step and the particle generation step are changed in accordance with Tables 1 and 2.

However, the organometallic mixture is prepared by adding tetrabutoxy titanium (TBT) to tetramethoxysilane (TMOS) in accordance with a ratio between a total supply amount of tetramethoxysilane (TMOS) and a total supply amount of tetrabutoxy titanium (TBT) described in Table 1.

In addition, in the case of the silica composite particles a14, titanium diisopropoxy bis(acetylacetonate) (Orgatix TC-100, manufactured by Matsumoto Fine Chemical Co., Ltd.) is used in place of tetrabutoxy titanium (TBT) to obtain hydrophobic silica composite particles.

In the case of the silica composite particles a15, titanium tetraacetylacetonate (Orgatix TC-401, manufactured by Matsumoto Fine Chemical Co., Ltd.) is used in place of tetrabutoxy titanium (TBT) to obtain hydrophobic silica composite particles.

In the case of the silica composite particles a16, titanium di-2-ethylhexoxy bis(2-ethyl-3-hydroxyhexoxide) (Orgatix TC-200, manufactured by Matsumoto Fine Chemical Co., Ltd.) is used in place of tetrabutoxy titanium (TBT) to obtain hydrophobic silica composite particles.

In the case of the silica composite particles a17, titanium diisopropoxy bis (ethyl acetoacetate) (Orgatix TC-750, manufactured by Matsumoto Fine Chemical Co., Ltd.) is used in place of tetrabutoxy titanium (TBT) to obtain hydrophobic silica composite particles.

Titanium Particles c1

As titanium particles c1, titanium oxide particles TT0-55 (C) (manufactured by Ishihara Sangyo Kaisha, Ltd., average particle size: 45 nm) that are available on the market are directly used.

### Examples 1 to 17 and Comparative Example 1 to 9

2 parts of silica composite particles according to Table 3 are added to 100 parts of toner particles, and mixed at 2000 rpm for 3 minutes by a Henschel mixer to obtain each toner.

Each obtained toner and a carrier are put into a V-blender at a ratio of 5:95 (toner:carrier) (weight ratio) and stirred for 20 minutes to obtain each developer.

As the carrier, a carrier prepared as follows is used.

Ferrite Particles (volume average particle size: 50 μm): 100 parts

Toluene: 14 parts

Styrene-Methyl Methacrylate Copolymer (component ratio: 90/10, Mw: 80000): 2 parts

Carbon Black (R330, manufactured by Cabox Corporation): 0.2 part

First, the above components, excluding the ferrite particles, are stirred for 10 minutes by a stirrer to prepare a coating liquid in which the components are dispersed by stirring. Next, the coating liquid and the ferrite particles are put into a vacuum degassing-type kneader and stirred for 30 minutes at 60° C., and then degassed by reducing the pressure while performing heating and dried, thereby obtaining a carrier.

Physical Properties

Physical Properties of Silica Composite Particles

Regarding the silica composite particles of the toner obtained in each of the examples, the content of titanium, the average particle size, the particle size distribution, and the average circularity are examined in accordance with the above-described methods, respectively.

Regarding the obtained silica composite particles a1 to a9 and b1 to b9, the content of titanium is quantified with the NET intensity of the constituent element in the particles using a fluorescent X-ray analyzer XRF 1500 (manufactured by Shimadzu Corporation), and examined by performing mapping using SEM-EDX (manufactured by Hitachi, Ltd., S-3400N). As a result, it is confirmed that titanium is present and dispersed without unevenness in the silica composite particles.

Experimental Evaluation

A developing machine of a modified “DocuCentre Color 400” (manufactured by Fuji Xerox Co., Ltd.) is filled with the electrostatic charge image developer obtained in each of the examples, and the transfer efficiency, fogging, and image density are evaluated.

Transfer Efficiency

The transfer efficiency is evaluated as follows. As for test procedures, first, a developing potential is adjusted so that a toner amount is 5 g/m² on a photoreceptor under the environment of a temperature 10° C. and a humidity of 20 RH %. Next, the evaluation machine is stopped immediately after transfer of the toner developed on the photoreceptor to an intermediate transfer member (intermediate transfer belt). Therefore, the toner remains on the photoreceptor in the post-transfer state (before cleaning). This toner is collected using mending tape, and a toner weight at that time is measured. The transfer efficiency is calculated from a ratio between the toner amount at the time of developing and the toner amount after transfer on the basis of the following expression. The transfer efficiency is measured after continuous output of an image having an image area of 5% on 50000 pieces of A4 paper. In addition, as an initial state, the transfer efficiency is measured also before the continuous output on 50000 pieces of paper.

Transfer Efficiency=Toner Amount on Paper after Transfer/Toner Amount on Photoreceptor×100 Expression:

The transfer efficiency evaluation standards are as follows.

A: 98% or greater in Transfer Efficiency

B: From 95% to less than 98% in Transfer Efficiency

C: From 90% to less than 95% in Transfer Efficiency

D: From 85% to less than 90% in Transfer Efficiency

E: Less than 85% in Transfer Efficiency

Fogging

An image having an image density of 20% and a size of 4 cm×4 cm is output on 50000 pieces of A4 paper under the condition of 25° C./80% RH, and the fogging of the 10th output image (in the Table, “initial”) and the fogging of the 50000th output image are evaluated as follows. The output image is visually evaluated (the presence of the toner on the non-image part is confirmed through a loupe).

The evaluation standards are as follows.

A: No fogging occurs.

B: Slight fogging occurs, but there are no problems in image quality.

C: Fogging occurs.

Image Density Fluctuation

An image having an image density of 20% and a size of 4 cm×4 cm is output on 50000 pieces of A4 paper under the condition of 25° C./80% RH, and the image density fluctuation of the 10th output image (in the Table, “initial”) and the image density fluctuation of the 50000th output image are measured using X-rite 938 (manufactured by X--rite).

The evaluation standards are as follows.

A: 0.5 or less in Density Difference

B: Exceeding 0.5, 1.0 or less in Density Difference

C: Exceeding 1.0, 1.5 or less in Density Difference

D: Exceeding 1.5, 2.0 or less in Density Difference

E: Exceeding 2.0 in Density Difference

Table 3 shows a list of the evaluation results together with the characteristics of the silica composite particles as an external additive.

TABLE 1

| | | | | Particle Generation Step | | | | | |
|---|---|---|---|---|---|---|---|---|---|
| | | | | (Organometallic Mixture and Ammonia Water Supply Conditions) | | | | | |
| | | | | | | | Supply | | |
| | | | | | | | Amount of | | |
| | | | | | | | Organometallic | | Supply Amount |
| | | | | | | | Compounds | | of NH₃ (mol |
| | Alkali | | | | | | (Supply Amount | | (Number of |
| | Catalyst Solution | | | | | Total | with respect | | Moles per 1 mol |
| | Preparation Step | | | | | Supply | to Number | Total | of Total Supply |
| | (Composition of Alkali | | | Total Supply | Total | Amount of | of Moles | Supply | Amount of |
| | Catalyst Solution) | | | Amount of | Supply | Organic | of Alcohol | Amount of | Organometallic |
| | | Ammonia | | Organometallic | Amount | Titanium | in Alkali | Ammonia | Compounds to |
| Silica | Methanol | Water | NH₃ | Mixture | of TMOS | Compound | Catalyst | Water | be Supplied |
| Composite | Number of | Number of | Amount | Number of | Number | Number of | Solution) | Number of | per Minute)) |
| Particles | Parts | Parts | (mol/L) | Parts | of Parts | Parts | (mol/mol · min) | Parts | (mol) |
| a1 | 400 | 75 | 0.75 | 220 | 214 | 6 | 0.0019 | 174 | 0.27 |
| a2 | 400 | 75 | 0.75 | 220 | 199 | 21 | 0.0017 | 174 | 0.27 |
| a3 | 400 | 80 | 0.79 | 220 | 220 | 0.002 | 0.0019 | 174 | 0.35 |
| a4 | 400 | 65 | 0.66 | 85 | 83 | 2 | 0.0010 | 67 | 0.27 |
| a5 | 400 | 65 | 0.66 | 800 | 778 | 22 | 0.0068 | 632 | 0.27 |
| a6 | 400 | 70 | 0.71 | 220 | 207 | 13 | 0.0018 | 174 | 0.27 |
| a7 | 400 | 59 | 0.61 | 220 | 214 | 6 | 0.0019 | 174 | 0.27 |
| a8 | 400 | 88 | 0.85 | 220 | 214 | 6 | 0.0019 | 174 | 0.27 |
| a9 | 400 | 75 | 0.75 | 220 | 214 | 6 | 0.0019 | 174 | 0.11 |
| a10 | 400 | 75 | 0.75 | 220 | 214 | 6 | 0.0012 | 174 | 0.39 |
| a11 | 400 | 75 | 0.75 | 140 | 136 | 4 | 0.0100 | 111 | 0.27 |
| a12 | 400 | 75 | 0.75 | 1200 | 1166 | 34 | 0.0091 | 948 | 0.27 |
| a13 | 400 | 55 | 0.57 | 80 | 78 | 2 | 0.0010 | 63 | 0.27 |
| a14 | 400 | 75 | 0.75 | 220 | 213 | 7 | 0.0019 | 174 | 0.27 |
| a15 | 400 | 75 | 0.75 | 220 | 213 | 7 | 0.0019 | 174 | 0.27 |
| a16 | 400 | 75 | 0.75 | 220 | 213 | 7 | 0.0019 | 174 | 0.27 |
| a17 | 400 | 75 | 0.75 | 220 | 213 | 7 | 0.0019 | 174 | 0.27 |

TABLE 2

| | | | | Particle Generation Step | | | | | |
|---|---|---|---|---|---|---|---|---|---|
| | | | | (Organometallic Mixture and Ammonia Water Supply Conditions) | | | | | |
| | | | | | | | Supply | | |
| | | | | | | | Amount of | | |
| | | | | | | | Organometallic | | Supply Amount |
| | | | | | | | Compounds | | of NH₃ (mol |
| | Alkali | | | | | | (Supply Amount | | (Number of |
| | Catalyst Solution | | | | | Total | with respect | | Moles per 1 mol |
| | Preparation Step | | | | | Supply | to Number | Total | of Total Supply |
| | (Composition of Alkali | | | Total Supply | Total | Amount of | of Moles | Supply | Amount of |
| | Catalyst Solution) | | | Amount of | Supply | Organic | of Alcohol | Amount of | Organometallic |
| | | Ammonia | | Organometallic | Amount | Titanium | in Alkali | Ammonia | Compounds to |
| Silica | Methanol | Water | NH₃ | Mixture | of TMOS | Compound | Catalyst | Water | be Supplied |
| Composite | Number of | Number of | Amount | Number of | Number | Number of | Solution) | Number of | per Minute)) |
| Particles | Parts | Parts | (mol/L) | Parts | of Parts | Parts | (mol/mol · min) | Parts | (mol) |
| b1 | 400 | 75 | 0.75 | 220 | 220 | 0 | 0.0019 | 174 | 0.27 |
| b2 | 400 | 75 | 0.75 | 220 | 194 | 26 | 0.0017 | 174 | 0.27 |
| b3 | 400 | 65 | 0.59 | 90 | 87 | 3 | 0.0010 | 71 | 0.27 |
| b4 | 400 | 65 | 0.59 | 950 | 924 | 26 | 0.0080 | 751 | 0.27 |
| b5 | 400 | 65 | 0.58 | 220 | 214 | 6 | 0.0019 | 174 | 0.20 |
| b6 | 400 | 55 | 0.58 | 220 | 214 | 6 | 0.0019 | 174 | 0.09 |
| b7 | 400 | 95 | 0.92 | 220 | 214 | 6 | 0.0019 | 174 | 0.41 |
| b8 | 400 | 75 | 0.75 | 1300 | 1264 | 36 | 0.0110 | 1027 | 0.27 |

TABLE 3

| | | | | | | Evaluation | | | | |
|---|---|---|---|---|---|---|---|---|---|---|
| | | Physical Properties of Silica Composite Particles | | | | Transfer Efficiency | | | | |
| | | | Average | | | (%) | | Fogging | | |
| | Silica | Ti Content | Particle | Particle Size | | | After Output on | | After Output on | |
| | Composite | (% by | Size | Distribution | Average | | 50000 Pieces of | | 50000 Pieces of | Density |
| | Particles | weight) | (nm) | Index | Circularity | Initial | Paper | Initial | Paper | Fluctuation |
| Example 1 | a1 | 2.8 | 125 | 1.33 | 0.73 | A | A | A | A | A |
| Example 2 | a2 | 9.6 | 122 | 1.47 | 0.53 | A | A | A | A | B |
| Example 3 | a3 | 0.001 | 130 | 1.12 | 0.83 | A | A | A | A | B |
| Example 4 | a4 | 2.7 | 76 | 1.24 | 0.80 | B | B | A | A | B |
| Example 5 | a5 | 2.8 | 470 | 1.28 | 0.82 | A | A | B | B | B |
| Example 6 | a6 | 5.8 | 155 | 1.37 | 0.65 | A | A | A | B | B |
| Example 7 | a7 | 2.8 | 133 | 1.39 | 0.61 | A | B | A | B | B |
| Example 8 | a8 | 2.8 | 128 | 1.28 | 0.84 | A | B | A | B | B |
| Example 9 | a9 | 2.8 | 140 | 1.34 | 0.71 | A | A | A | A | A |
| Example 10 | a10 | 2.8 | 150 | 1.30 | 0.80 | A | A | A | A | B |
| Example 11 | a11 | 2.9 | 151 | 1.31 | 0.77 | A | A | A | A | B |
| Example 12 | a12 | 2.8 | 490 | 1.29 | 0.63 | A | A | A | B | B |
| Example 13 | a13 | 2.8 | 31 | 1.21 | 0.81 | A | C | B | B | C |
| Example 14 | a14 | 2.9 | 152 | 1.31 | 0.72 | B | B | B | B | B |
| Example 15 | a15 | 2.8 | 150 | 1.29 | 0.72 | B | B | B | B | B |
| Example 16 | a16 | 2.8 | 148 | 1.28 | 0.74 | B | B | B | B | C |
| Example 17 | a17 | 2.8 | 144 | 1.28 | 0.73 | B | B | B | B | C |
| Comparative | b1 | 0 | 160 | 1.28 | 0.81 | B | C | B | C | E |
| Example 1 | | | | | | | | | | |
| Comparative | b2 | 12.0 | Particle Size Distribution Having Two | | | — | — | — | — | — |
| Example 2 | | | Peaks | | | | | | | |
| Comparative | b3 | 2.8 | 28 | 1.19 | 0.79 | C | E | B | C | E |
| Example 3 | | | | | | | | | | |
| Comparative | b4 | 2.7 | 552 | 1.21 | 0.80 | B | B | C | C | E |
| Example 4 | | | | | | | | | | |
| Comparative | b5 | 2.7 | 124 | 1.56 | 0.58 | A | A | C | C | D |
| Example 5 | | | | | | | | | | |
| Comparative | b6 | 2.7 | The particles do not have a particle form | | | — | — | — | — | — |
| Example 6 | | | (at a level where circularity is less than | | | | | | | |
| | | | 0.5) | | | | | | | |
| Comparative | b7 | 2.8 | 142 | 1.12 | 0.92 | B | C | B | B | D |
| Example 7 | | | | | | | | | | |
| Comparative | b8 | 2.8 | 507 | 1.26 | 0.58 | A | B | B | B | D |
| Example 8 | | | | | | | | | | |

| | | | | | | | |
|---|---|---|---|---|---|---|---|
| Comparative | c1 | TT0-55(C) | C | D | B | C | E |
| Example 9 | | | | | | | |

From the above results, it is found that in the examples, good results are obtained in each evaluation of the transfer efficiency, fogging, and image density fluctuation.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles; and
silica composite particles that contain silicon oxide and from 0.001% by weight to 10% by weight of titanium, and have an average particle size of from 30 nm to 500 nm, a particle size distribution index of from 1.10 to 1.50, and an average circularity of from 0.50 to 0.85.

2. The electrostatic charge image developing toner according to claim 1,
wherein the silica composite particles are obtained through preparing an alkali catalyst solution containing an alkali catalyst in an alcohol-containing solvent at a concentration of from 0.6 mol/L to 0.85 mol/L, and supplying, to the alkali catalyst solution, a mixture of a tetraalkoxysilane and an organic titanium compound with an organic group bonded to a titanium atom via an oxygen atom at a supply rate of from 0.001 mol/(mol·min) to 0.01 mol/(mol·min) with respect to alcohol, and supplying from 0.1 mol to 0.4 mol of an alkali catalyst per 1 mol of a total supply amount of the tetraalkoxysilane and the organic titanium compound to be supplied per minute.

3. The electrostatic charge image developing toner according to claim 1,
wherein the content of the titanium is from 0.01% by weight to 9% by weight.

4. The electrostatic charge image developing toner according to claim 1,
wherein the silica composite particles have the average particle size of from 100 nm to 350 nm.

5. The electrostatic charge image developing toner according to claim 1,
wherein the silica composite particles have the particle size distribution index of from 1.25 to 1.40.

6. The electrostatic charge image developing toner according to claim 1,
wherein the silica composite particles have the average circularity of from 0.60 to 0.80.

7. The electrostatic charge image developing toner according to claim 1,
wherein the content of the titanium is from 0.1% by weight to 5% by weight.

8. The electrostatic charge image developing toner according to claim 2,
wherein the organic titanium compound contains an alkoxy group.

9. An electrostatic charge image developer comprising:
an electrostatic charge image developing carrier; and
an electrostatic charge image developing toner,
wherein the electrostatic charge image developing toner is the electrostatic charge image developing toner according to claim 1.

10. A toner cartridge that is detachable from an image forming apparatus, and contains an electrostatic charge image developing toner,
wherein the electrostatic charge image developing toner is the electrostatic charge image developing toner according to claim 1.

11. A process cartridge that is detachable from an image forming apparatus, and has a developing unit that develops an electrostatic charge image formed on a surface of a latent image holding member with an electrostatic charge image developer to form a toner image,
wherein the electrostatic charge image developer is the electrostatic charge image developer according to claim 9.

12. An image forming apparatus comprising:
a latent image holding member;
a charging unit that charges a surface of the latent image holding member;
an electrostatic charge image forming unit that forms an electrostatic charge image on a charged surface of the latent image holding member;
a developing unit that develops the electrostatic charge image with an electrostatic charge image developer to form a toner image;
a transfer unit that transfers the toner image onto a recording medium; and
a fixing unit that fixes the toner image to the recording medium,
wherein the electrostatic charge image developer is the electrostatic charge image developer according to claim 9.

13. An image forming method comprising:
charging a surface of a latent image holding member;
forming an electrostatic charge image on a charged surface of the latent image holding member;
developing the electrostatic charge image with the electrostatic charge image developer according to claim 9 to form a toner image;
transferring the toner image onto a recording medium; and
fixing the toner image to the recording medium.
